(19) United States
(12) Patent Application Publication
(10) Pub. No.: US 2015/0096541 A1
(43) Pub. Date: Apr. 9, 2015

(54) BOOST PURGE EJECTOR TEE ARRANGEMENT

(71) Applicants: Daniel H. Edmund, Brighton, MI (US); Roger C. Sager, Munith, MI (US); William B. Blomquist, Lake Orion, MI (US); Michael R. Grote, Rochester Hills, MI (US); Frederick A. Gibb, Clawson, MI (US); Christopher G. Hadre, LaSalle (CA)

(72) Inventors: Daniel H. Edmund, Brighton, MI (US); Roger C. Sager, Munith, MI (US); William B. Blomquist, Lake Orion, MI (US); Michael R. Grote, Rochester Hills, MI (US); Frederick A. Gibb, Clawson, MI (US); Christopher G. Hadre, LaSalle (CA)

(21) Appl. No.: 14/048,790

(22) Filed: Oct. 8, 2013

(51) Int. Cl. F02M 25/08

(52) U.S. Cl. CPC F02M 25/08
USPC 123/520

(57) ABSTRACT

A boost purge ejector tee arrangement for a fuel vapor emissions system can include a boost purge ejector tee having a body that can define a first inlet port, a second inlet port and an outlet port. The first inlet port and the outlet port can be fluidly coupled along a first flow path. The body can define a second flow path from the second inlet port that can intersect the first flow path upstream of the outlet port. A nozzle can be positioned in the first flow path such that an outlet of the nozzle can be proximate the intersection of the second flow path with the first flow path. The boost purge ejector tee can be integrated into an air box that can be associated with an engine such that the outlet port exits into an inside of the air box.

### FIELD

The present disclosure relates generally to an evaporative fuel emissions system for an engine and, more particularly, to a boost purge ejector tee arrangement in an evaporative fuel emissions system for an engine that includes forced induction.

### BACKGROUND

Modern internal combustion engines can generate hydrocarbon emissions by evaporative means and, as a result, vehicle fuel vapor emissions to the atmosphere are regulated. For the purpose of preventing fuel vapor from escaping to the atmosphere, an Evaporative Emissions Control (EVAP) system is typically implemented to store and subsequently dispose of fuel vapor emissions. The EVAP system can be designed to collect vapors produced inside an engine's fuel system and then send them through an engine's intake manifold into its combustion chamber to get burned up as part of the aggregate fuel-air charge. When pressure inside the vehicle's fuel tank reaches a predetermined level as a result of evaporation, the EVAP system can transfer the vapors to a purge canister. Subsequently, when engine operating conditions are conducive, a purge valve can open and vacuum from the intake manifold can draw the vapor to the engine's combustion chamber. Thereafter, the purge canister is regenerated with newly formed fuel vapor, and the cycle can continue.

In addition to fuel vapor recovery function, an EVAP system can be required to perform a leak-detection function. To that end, a known analog leak-detection scheme can employ an evaporative system integrity monitor (ESIM) switch which stays on if the system is properly sealed, and toggles off when a system leak is detected. When the ESIM switch is toggled off, an engine control unit (ECU) detects the change and alerts an operator of the vehicle with a malfunction indicator.

In view of the above, the inventors have recognized a need for an apparatus and methodology that permits an EVAP system to accomplish its prescribed fuel evaporative emissions purge and leak detection functions in forced induction applications.

### SUMMARY

In one form, a boost purge ejector tee arrangement for a fuel vapor emissions system is provided in accordance with the teachings of the present disclosure. The fuel vapor emissions system can be coupled to an intake manifold of an engine with a forced induction system. The boost purge ejector tee arrangement can include a boost purge ejector tee having a body that can define a first inlet port, a second inlet port and an outlet port. The first inlet port and the outlet port can be fluidly coupled along a first flow path. The body can define a second flow path from the second inlet port that can intersect the first flow path upstream of the outlet port. A nozzle can be positioned in the first flow path such that an outlet of the nozzle can be proximate the intersection of the second flow path with the first flow path. The boost purge ejector tee can be integrated into an air box that can be associated with the engine such that the outlet port exits into an inside of the air box.

In another form, a boost purge ejector tee arrangement for a fuel vapor emissions system is provided in accordance with the teachings of the present disclosure. The fuel vapor emissions system can be coupled to an intake manifold of an internal combustion engine with a forced induction system, and can be of the type including a purge canister and a purge valve. The boost purge ejector tee arrangement can include a boost purge ejector tee integrated into an air box associated with the engine. The boost purge ejector tee can include a body that can define a first inlet port, a second inlet port and an outlet port. The first inlet port and the outlet port can be fluidly coupled along a first flow path. The body can define a second flow path from the second inlet port that can intersect the first flow path upstream of the outlet port. The outlet port can exit into an inside of the air box and the first and second inlet ports can be positioned external to the air box. A venturi nozzle can be positioned in the first flow path such that an outlet of the venturi nozzle can be proximate the intersection of the second flow path with the first flow path. The first inlet port can be directly coupled to an outlet of the forced induction system and the second inlet port can be in direct fluid communication with the purge valve. During a boost operational mode, the first inlet port can be adapted to receive boost air flow, which can flow through the venturi nozzle thereby creating a vacuum and drawing purge through the second inlet port.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic diagram of an EVAP system of a typical internal combustion engine with forced induction;

FIG. 2 is a schematic diagram of an EVAP system having an exemplary boost purge ejector arrangement for an internal combustion engine with forced induction according to the principles of the present disclosure;

FIG. 3 is a perspective view of an exemplary air box with the boost purge ejector tee arrangement associated therewith according to the principles of the present disclosure;

FIG. 4A is a partial perspective view of the air box with the boost purge ejector tee arrangement associated therewith according to the principles of the present disclosure;

FIG. 4B is a partial perspective view of an inside of the air box with the boost purge ejector tee arrangement associated therewith according to the principles of the present disclosure;

FIG. 5A is a perspective view of the boost purge ejector tee according to the principles of the present disclosure; and

FIG. 5B is a sectional view of the boost purge ejector tee according to the principles of the present disclosure.

### DESCRIPTION

The present disclosure relates to a boost purge ejector tee arrangement for an engine, such as an internal combustion engine, with forced induction. The boost purge ejector arrangement can be associated with an EVAP system and can facilitate the EVAP system performing its prescribed fuel evaporative emissions purge and leak detection functions in forced induction applications, while cooperating with the EVAP system to ensure that various potential system leak points can be detected with the leak detection function. In one exemplary implementation, the boost purge ejector tee arrangement can include a boost purge ejector tee integrated with an air box. Such an arrangement can eliminate fluid flow lines and connections from the EVAP system, which can reduce complexity and improve robustness of the EVAP system, including improved leak detection capability.

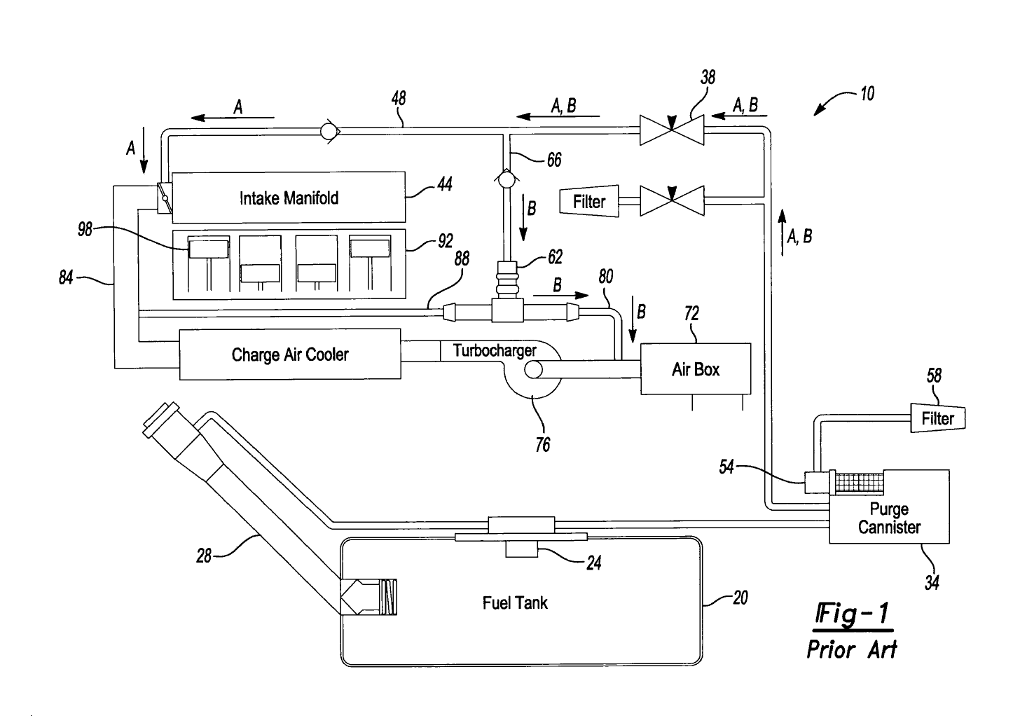

Referring now to the drawings, in which like reference numerals refer to like or similar features, FIG. 1 denotes an EVAP system 10 of a typical internal combustion engine with forced induction. EVAP system 10 can include a fuel tank 20 in fluid communication with a pressure sensor 24 and a fill neck 28. A purge canister 34 can be in fluid communication with fuel tank 20 for capturing fuel vapor from the fuel tank 20. Purge canister 34 can additionally be in fluid communication with a purge valve 38, which can release the purge canister's fuel vapor contents to an intake manifold 44 via fluid line 48 in response to engine manifold vacuum. Purge canister 34 can also be in fluid communication with an evaporative system integrity monitor (ESIM) switch 54, which is configured to stay on if the EVAP system is operatively sealed in the presence of engine vacuum, and to toggle off if the EVAP system experiences a leak (loss of vacuum). ESIM switch 54 can be in fluid communication with atmosphere via a filter 58.

The purge valve 38 can also be in fluid communication with a multi-port connection member 62 via a fluid line 66. Multi-port connection member 62 can be in fluid communication with an air box 72 and/or inlet line to a turbocharger 76 via a fluid line 80. Multi-port connection member 62 can also be in fluid communication with a turbocharger output line or air tube 84 via a fluid line 88. The turbocharger output line 84 can connect an output of turbocharger 76 to intake manifold 44. Intake manifold 44 can communicate vacuum generated by an engine's 92 reciprocating pistons 98, or boost pressure supplied by the exhaust-driven turbocharger 76, a crankshaft-driven supercharger (not shown), or any other pressurizing means, as is readily understood by those skilled in the art.

In a naturally aspirated mode, the purge valve 38 can be controlled to allow flow therethrough, and purge (e.g., fuel vapor drawn from purge canister 34) can flow to the intake manifold 44 in a flow path depicted by arrows A in FIG. 1. The fuel vapor can be drawn from purge canister 34 by intake manifold vacuum and the drawn fuel vapor can be transferred via intake manifold 44 to the engine's combustion chamber (not shown) to be burned with the main fuel-air charge. In a boost condition facilitated by turbocharger 76, purge can flow in the direction of arrows B through purge valve 38 into multi-port connection member 62 via fluid line 66 and into the turbocharger inlet via fluid line 80. The high pressure airflow from turbocharger 76 can flow through fluid line 88 and multi-port connection member 62, thereby drawing purge into fluid line 66 in the manner discussed above.

In addition to the fuel vapor recovery function, the EVAP system is also required to perform a leak detection function. In this regard, pressure sensor 24 can be associated with the fuel tank 20 for measuring a system pressure. The pressure at the pressure sensor 24 can be monitored by a vehicle controller or the like (not specifically shown) during operation and the vehicle and/or EVAP system to sense feedback, as is readily understood by those skilled in the art. For example, when the EVAP system 10 is operating in a boost condition, if the fluid line 88 becomes disconnected or pinched, there will be a significant reduction in flow through multi-port connection member 62. This can result in a significantly reduced draw or flow of purge through fluid line 66. This reduction in purge flow will be sensed by pressure sensor 24 in the form of a lack of vacuum in fuel tank 20. Similarly, if fluid line 66 is disconnected in the boost operating mode, purge flow cannot be drawn therethrough and thus there will also be a corresponding lack of vacuum detected at pressure sensor 24. For example, the vacuum pressure can be lower than a predetermined threshold.

If fluid line 80 becomes disconnected, however, such a scenario can potentially remain undetected by the EVAP system 10 leak detection function. With fluid line 80 disconnected, ruptured, etc., purge in a boost mode of operation can potentially flow to the atmosphere instead of into the engine in the manner discussed above. A disconnection of line 80 can be undetected by the leak detection function of EVAP system 10 in the boost mode of operation because positive pressure airflow from the turbocharger 76 flowing through fluid line 88 will draw purge from canister 34 through fluid line 66 regardless of whether line 88 is connected or disconnected. As a result, pressure sensor 24 can detect vacuum pressure above the predetermined threshold due to the purge flow in boost even when fluid line 88 is disconnected.

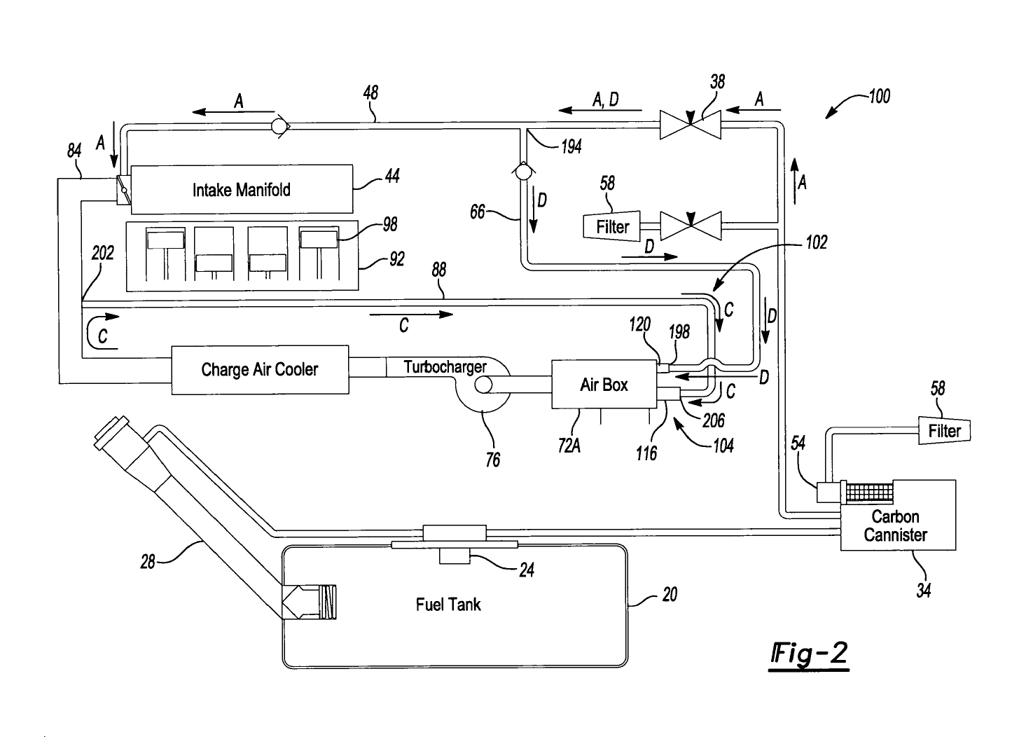

Turning now to FIGS. 2-5B, an EVAP system is shown and generally identified at reference numeral 100 in accordance with the principles of the present disclosure. EVAP system 100 can include a boost purge ejector tee arrangement 102 configured to provide improved leak detection functionality while also reducing cost and complexity by eliminating components from the EVAP system 100. As will be discussed in greater detail below, in one exemplary implementation, the boost purge ejector tee arrangement 102 can be integrated with the air box thereby eliminating the connection line 80 of EVAP system 10. Thus EVAP system 100 can provide a more robust system with fewer components and potential leak paths while also improving leak detection capabilities and reducing cost.

In the exemplary schematic illustration of EVAP system 100 shown in FIG. 2, where like reference numerals refer to like components in the various figures, EVAP system 100 can include the boost purge ejector tee arrangement 102 associated with air box 72A. In one exemplary implementation, boost purge ejector tee arrangement 102 can include a boost purge ejector tee 104 directly coupled to the air box 72A. As briefly discussed above, this arrangement can eliminate the fluid line 80, which can eliminate multiple potential leak paths as well as eliminate a portion of the EVAP system 10 that is potentially not detectable in a leaking condition.

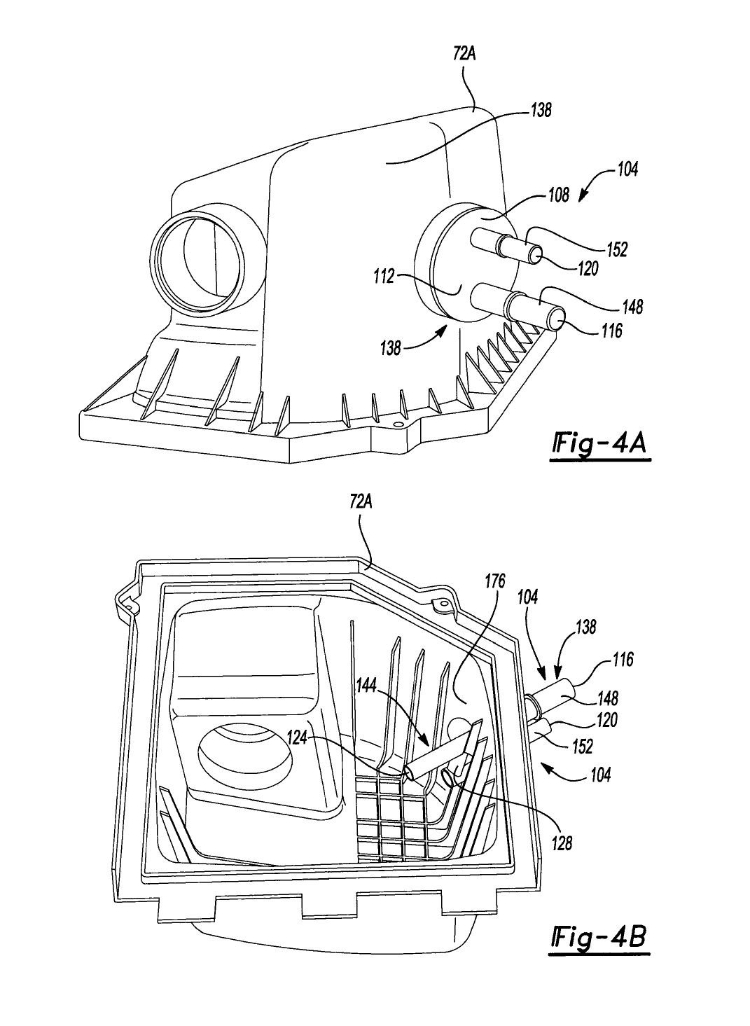

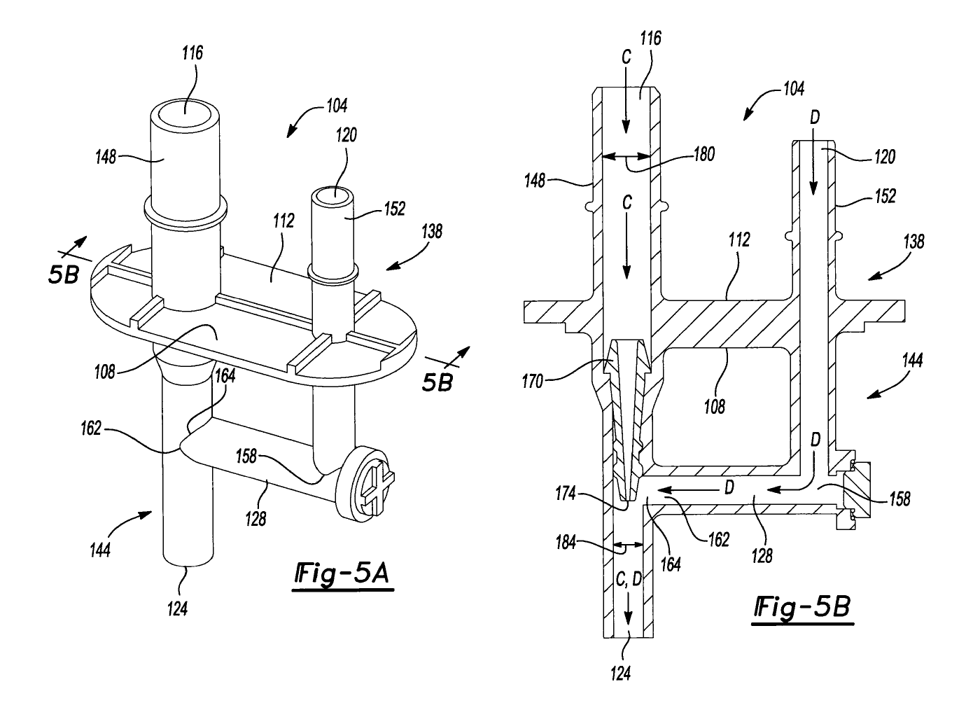

With particular reference to FIGS. 4A-5B, the boost purge ejector tee 104 will now be described in detail. In the exemplary configuration illustrated, the boost purge ejector tee 104 can include a body 108 defining a mounting member 112, a first inlet port 116, a second inlet port 120, an outlet port 124 and a connecting member 128 fluidly coupling the two inlet ports 116, 120 to the outlet port 124. In one exemplary implementation, the first inlet port 116 and the outlet port 124 can be coaxial or substantially coaxial. It should be understood that while the discussion will continue with reference to the boost purge ejector tee 104 having a mounting member 112 defined by body 108, the boost purge ejector tee 104 could be configured with or without the mounting member 112.

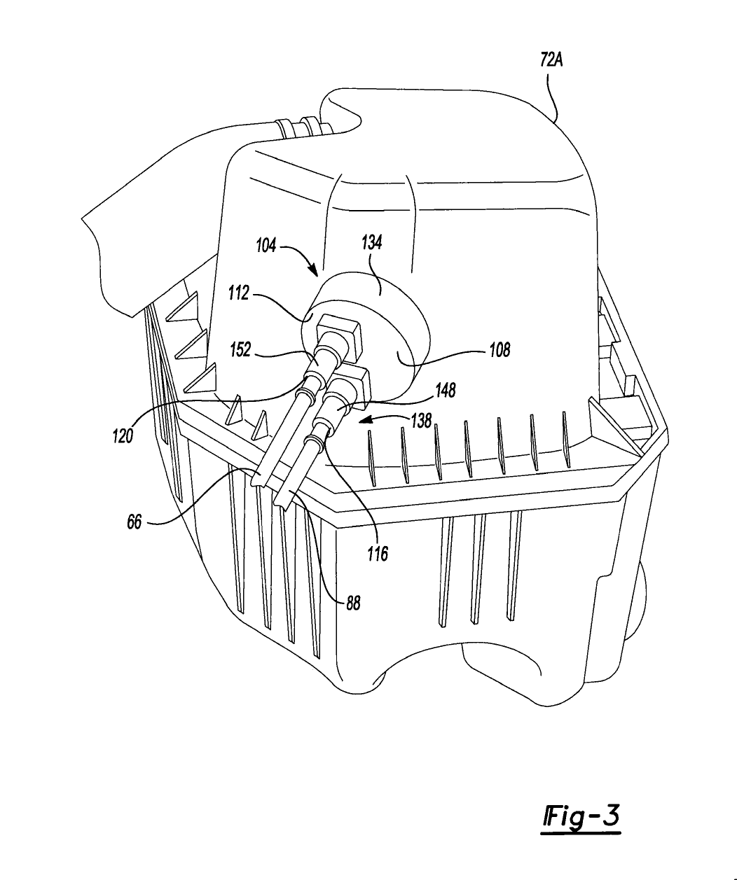

The mounting member 112 can be any suitable member configured to facilitate mounting and/or aligning the boost purge ejector tee with the air box 72A. In the exemplary implementation illustrated, the mounting member 112 can be in the form of a flange having a circular or oval shape, as shown for example in FIGS. 4A-5B. It should be appreciated, however, that the mounting member can be provided in various forms or shapes as may be desired or required by, for example, packaging considerations. In one exemplary implementation, the size and shape of the mounting member 112 can correspond to a mounting boss or area 134 formed on the air box. The mounting boss 134, in the exemplary implementation illustrated, can be configured to receive the mounting member 112, as shown for example in FIGS. 3-4B.

For discussion purposes, the mounting member 112 can essentially divide the boost purge ejector tee 104 into an external side 138 configured to be positioned outside or substantially outside the air box 72A when mounted thereto and an opposed internal side 144 configured to be positioned inside or substantially inside the air box 72A when mounted thereto. The external side 138 can include the first and second inlet ports 116, 120. In one exemplary implementation, the external side 138 can include first and second tubes or nipples 148, 152 defining the respective first and second inlet ports 116, 120. As will be discussed in greater detail below, fluid line 88 can be directly connected to first inlet port 114 and fluid line 66 can be directly connected to second inlet port 120.

The first and second tubes 148, 152 can extend through the mounting member 112 to the internal side 144, as shown for example in FIGS. 5A and 5B. The connecting member 128 can fluidly couple the first and second tubes 148, 152 on the internal side 144 of the mounting member 112, as also shown in FIGS. 5A and 5B. The connecting member 128 can include an inlet side 158 adjacent or coupled to the second tube 152 and an outlet side 162 adjacent or coupled to the first tube 148. In one exemplary implementation, the outlet side 162 can intersect the first tube 148 at an intersection point 164.

The boost purge ejector tee 104 can include a nozzle, such as a venturi nozzle 170, positioned in the first tube 148. In the exemplary implementation illustrated, the venturi nozzle 170 can be positioned such that its outlet 174 is positioned downstream and proximate the outlet side 162 of the connecting member 128. In this implementation, the outlet 174 can be positioned proximate the intersection 164. As will be discussed in greater detail below, the venturi nozzle 170 can creature a vacuum effect due to the increased velocity of the flow therethrough thereby drawing fluid through the connecting member 128 in a direction from the inlet side 158 to the outlet side 162.

The body 108 of the boost purge ejector tee 104 can define a first flow path from the first inlet port 116 through the venturi nozzle 170 and to the outlet port 124. In one exemplary implementation, the first inlet port 116 and the outlet port 124 can be in direct fluid communication via the first flow path. The body 108 can also define a second flow path from the second inlet port 120 to the intersection point 164 with the first flow path. The second inlet port 120 can also be in direct fluid communication with the outlet port 124 via the connecting member 128 and a portion of the first tube 148 downstream of the venturi nozzle 170.

In the exemplary implementation illustrated, the first tube 148 can include a larger diameter 180 upstream of the venturi nozzle 170 and a smaller diameter 184 downstream of the venturi nozzle 170. A beginning of the smaller diameter 184 can be positioned upstream of the intersection 164 of the connecting member 128 and the first tube 148, as shown for example in FIGS. 5A and 5B. In this exemplary implementation, the venturi nozzle 170 can be positioned perpendicular or substantially perpendicular to the connecting member 128. The first tube 148 can extend beyond the connecting member 128 and define the outlet port 124. The outlet port 124 can facilitate the fluid flowing therethrough entering an inside 176 of the air box 72A, as shown for example in FIG. 4B. In one exemplary implementation, the first inlet port 116 can include a larger diameter than the second inlet port 120.

It should be appreciated that while the boost purge ejector tee 104 is discussed above as having a particular configuration of first and second tubes 148, 152 relative to the connecting member 128, various different configurations and/or orientations of the first tube 148 or second tube 152 could be implemented while still placing the venturi nozzle outlet 174 adjacent the outlet side of the connecting member 128. In one exemplary implementation, the connecting member 128 could be eliminated and the first tube 148 could be orientated relative to the second tube 152 so as to place the venturi nozzle 170 perpendicular or substantially perpendicular to the second tube 152. In another exemplary implementation, the connecting member 128 could be eliminated and an outlet of the second tube 152 could be orientated perpendicular or substantially perpendicular to the first tube 148 adjacent the venturi nozzle 170 outlet 174.

It should also be appreciated that while the above discussion references a connecting member 128, this member could be an integral portion of the first or second tubes 148, 152. In this regard, the boost purge ejector tee 104 can be formed as an integral or unitary component or separate components coupled or assembled together. Various materials and manufacturing methods can be used to form the boost purge ejector tee 104, including forming a polymeric boost purge ejector tee 104 using an injection molding process.

With particular reference to FIG. 2 and continuing reference to FIGS. 3-5B, operation of the EVAP system 100 will now be discussed in greater detail. As briefly mentioned above, EVAP system 100 can include the boost purge ejector tee arrangement 102, which can replace the external multi-port connection member 62 and fluid line 80 with the boost purge ejector tee 104 integrated into the air box 72A. This boost purge ejector tee arrangement 102 can thereby reduce complexity and improve robustness of the EVAP system 100, including improved leak detection capability.

The EVAP system 100 can include the fluid line 66 coupled at one end 194 to fluid line 48 and at an opposite end 198 directly to second inlet port 120 of the boost purge ejector tee 104. In one exemplary implementation, the fluid line 66 can provide direct fluid communication between the second inlet port 120 and the purge valve 38. The fluid or air line 88 can be coupled at one end 202 to the turbocharger output line 84 and at an opposite end 206 directly to the first inlet port 116. In one exemplary implementation, the fluid line 88 can provide direct fluid communication between the first inlet port 116 and the air line 88. This boost purge ejector tee arrangement 102 can, as discussed above, eliminate the need for fluid line 80 and at least one connection associated therewith.

In operation, in a naturally aspirated mode, the purge valve 38 can be controlled to allow flow therethrough, and purge can flow to the intake manifold 44 in a flow path depicted by arrows A in FIG. 2. The purge can be drawn from purge canister 34 by intake manifold vacuum and can be transferred via intake manifold 44 to the engine's combustion chamber (not specifically shown) to be burned with the main fuel-air charge. In a boost mode of operation facilitated by turbocharger 76, high pressure air (boost air) flow from turbocharger 76 having a higher pressure than manifold pressure can flow to the intake manifold 44 through air tube 84. High pressure or boost air flow from turbocharger 76 can also flow through air line 88 in the direction of arrows C and into boost purge ejector tee 104 via first inlet port 116, as shown for example in FIG. 2.

From the first inlet port 116, the high pressure or boost air can flow through venturi nozzle 170, which can create a low pressure or vacuum thereby drawing purge through second inlet port 120 and into air box 72A via outlet port 124. In particular, the vacuum created from the boost air flow through venturi nozzle 170 can draw purge along the flow path of arrows D through purge valve 38, through fluid line 66 and directly into second inlet port 120. From second inlet port 120, the purge can be drawn and thus can flow through connecting member 128 and into first tube 148 downstream of the venturi nozzle outlet 174 where it can mix with the boost air flowing toward and through outlet port 124 into air box 72A.

With the boost purge ejector tee arrangement 102 of EVAP system 100, a leak or broken flow condition in fluid lines 66 and 88 can be detected in the manner discussed above. As can be seen in at least FIG. 2, the flow line 80 has been eliminated in EVAP system 100, thereby removing the non-detectable portion of the EVAP system 10 while improving robustness and reducing cost and complexity.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A boost purge ejector tee arrangement for a fuel vapor emissions system coupled to an intake manifold of an engine with a forced induction system, comprising:
a boost purge ejector tee having:
a body defining a first inlet port, a second inlet port and an outlet port, the first inlet port and the outlet port being fluidly coupled along a first flow path, the body defining a second flow path from the second inlet port that intersects the first flow path upstream of the outlet port; and
a nozzle positioned in the first flow path such that an outlet of the nozzle is proximate the intersection of the second flow path with the first flow path;
wherein the boost purge ejector tee is integrated into an air box associated with the engine such that the outlet port exits into an inside of the air box.

2. The boost purge ejector tee arrangement of claim 1, wherein the outlet port is positioned inside the air box and the first and second inlet ports extend external to the air box.

3. The boost purge ejector tee arrangement of claim 2, wherein the body further defines a mounting flange, the mounting flange adapted to engage the air box to connect the boost purge ejector tee thereto, the first and second outlet ports extending from a first side of the mounting flange and the outlet port extending from a second opposite side of the mounting flange.

4. The boost purge ejector tee arrangement of claim 3, wherein the body further defines a connecting portion on the second side of the mounting flange that forms at least a portion of the second flow path from the second inlet port to the intersection with the first flow path.

5. The boost purge ejector tee arrangement of claim 1, wherein the first inlet port includes a greater diameter than the second inlet port.

6. The boost purge ejector tee arrangement of claim 1, wherein the first inlet port and the outlet port are substantially coaxial.

7. The boost purge ejector tee arrangement of claim 1, wherein the first inlet port includes a greater diameter than the output port.

8. The boost purge ejector tee arrangement of claim 2, wherein the first inlet port is in fluid communication with a first air flow line adapted to receive boost pressure from the forced induction system during a boost mode; and
wherein the second inlet port is in fluid communication with a purge valve of the fuel vapor emissions system, which is in fluid communication with a purge canister of the fuel vapor emissions system.

9. The boost purge ejector tee arrangement of claim 8, wherein the nozzle comprises a venturi nozzle; and
wherein in a boost mode, the boost pressure flows through the first inlet port and the venturi nozzle, thereby creating a vacuum to draw purge from the purge canister into the first flow path and into the air box via the outlet port.

10. The boost purge ejector tee arrangement of claim 9, wherein the vacuum draws purge from the purge canister through the purge valve and into a fluid line in fluid communication with the purge valve and directly coupled to the second inlet port.

11. The boost purge ejector tee arrangement of claim 10, wherein the first inlet port is in direct fluid communication with the first air flow line, and wherein the second inlet port is in direct fluid communication with the purge valve.

12. The boost purge ejector tee arrangement of claim 11, wherein the boost purge ejector tee is directly connected to the air box.

13. The boost purge ejector tee arrangement of claim 12, wherein the body defines only two inlet ports, which are positioned external to the air box, and only one outlet port, which exits into the inside of the air box.

14. The boost purge ejector tee arrangement of claim 1, wherein the forced induction system includes a turbocharger.

15. A boost purge ejector tee arrangement for a fuel vapor emissions system coupled to an intake manifold of an internal combustion engine with a forced induction system and of the type including a purge canister and a purge valve, comprising:
a boost purge ejector tee integrated into an air box associated with the engine, the boost purge ejector tee having:
a body defining a first inlet port, a second inlet port and an outlet port, the first inlet port and the outlet port being fluidly coupled along a first flow path, the body defining a second flow path from the second inlet port that intersects the first flow path upstream of the outlet port, the outlet port exiting into an inside of the air box and the first and second inlet ports positioned external to the air box; and
a venturi nozzle positioned in the first flow path such that an outlet of the venturi nozzle is proximate the intersection of the second flow path with the first flow path;
wherein the first inlet port is directly coupled to an outlet of the forced induction system and the second inlet port is in direct fluid communication with the purge valve; and
wherein during a boost operational mode, the first inlet port is adapted to receive boost air flow, which flows through the venturi nozzle thereby creating a vacuum and drawing purge through the second inlet port.

16. The boost purge ejector tee arrangement of claim 15, wherein the body further defines a mounting flange, the mounting flange adapted to engage the air box to connect the boost purge ejector tee thereto, the first and second outlet ports extending from a first side of the mounting flange external to the air box and the outlet port extending from a second opposite side of the mounting flange inside the air box.

17. The boost purge ejector tee arrangement of claim 16, wherein the body defines only two inlet ports, which are positioned external to the air box, and only one outlet port, which exits into the inside of the air box.

18. The boost purge ejector tee arrangement of claim 15, wherein the vacuum draws purge from the purge canister through the purge valve and into a fluid line in direct fluid communication with the purge valve and directly coupled to the second inlet port.

19. The boost purge ejector tee arrangement of claim 15, wherein the second inlet port is in direct fluid communication with the first flow path and the outlet port.
